(19) United States
(12) Patent Application Publication
(10) Pub. No.: US 2004/0223246 A1
(43) Pub. Date: Nov. 11, 2004

(54) Master disk for magnetic duplication and a method for manufacturing the master disk

(76) Inventor: Hiroyuki Yoshimura, (US)

Correspondence Address: RABIN & Berdo, PC, 1101 14TH STREET, NW, SUITE 500, WASHINGTON, DC, 20005, US

(21) Appl. No.: 10/769,993

(22) Filed: Feb. 3, 2004

(30) Foreign Application Priority Data
Mar. 3, 2003 (JP) 2003-056319

(51) Int. Cl. G11B 5/09

(52) U.S. Cl. 360/48

(57) ABSTRACT

A master disk for magnetic duplication that perfectly avoids bit loss in a magnetic recording medium on which magnetic patterns of a master disk are duplicated. The master disk has a special region with a magnetization reversible area and a magnetization irreversible area around the magnetization reversible area in a region that is surrounded by a surrounding shape pattern of soft magnetic films. and. The special region has an area corresponding to one recordation pixel and allows secure reversal of magnetization.

### CROSS-REFERENCE TO RELATED APPLICATION

The entire disclosure of the inventors' corresponding Japanese patent application Serial No. JP PA 2003-056319, filed Mar. 3, 2003, is incorporated by reference.

### BACKGROUND OF THE INVENTION

1. Field of the Invention

The invention relates to a master disk for magnetic duplication and a method of fabrication. In particular, the master disk of the invention relates to a method to write servo signals for positioning a head for reading and writing data from and to a magnetic recording disk surface, or to write special data by using a magnetic duplication technique in a hard disk drive (hereinafter also referred to as “HDD”). The HDD uses a magnetic film as a recording material, and is a major external storage device for computers at present.

2. Description of the Related Art

Recording and readout of data in the HDD are performed by a magnetic head flying over the surface of a rotating magnetic recording medium by a levitation mechanism called a slider, keeping a distance of a few tens of nanometers above the disk surface. Bits of information on a magnetic recording medium are stored on data tracks arranged concentrically on the medium surface. A magnetic head is quickly moved and positioned at a target data track on the medium surface and records or reads out data.

Positioning signals (or servo signals) for detecting relative positions between the magnetic head and the data track are written concentrically on the surface of the magnetic recording medium. The magnetic head detects its own position at intervals while recording and reading out data. In order to avoid the center of the written servo signals being off-centered with respect to the center of the medium or the center of the course followed by the magnetic head as it flies over the magnetic recording medium, the servo signals are written after installing the medium into the HDD by using a dedicated apparatus called a servo writer. Recording density at the current stage of development of magnetic recording media, has reached as high as 100 G bits/in² in a recording capacity and is increasing at a rate of 60% per year. Consequently, year after year, the density of the servo signals for detecting the position of the head has necessarily increased, resulting in increases in the time required for writing the servo signals. The prolonged time for writing the servo signals is becoming a severe factor that lowers the productivity of the HDD and raises its cost.

Recently, a magnetic duplication technique is being developed, by which whole servo signals are magnetically transcribed at one time in place of a method to write servo signals using a signal writing head of the above-mentioned servo writer. This technique is expected to substantially shorten the time for writing the servo information.

FIGS. 11(a), 11(b), 11(c) and FIGS. 12(a), 12(b) illustrate the magnetic duplication technique in which the servo signals are written at one time using a signal writing head. (See the permanent magnet 110 in FIGS. 12(a) and 12(b).)

FIGS. 11(a), 11(b), and 11(c) show the process of magnetic duplication between a master disk 1 and a magnetic recording medium 100.

In the initial homogeneous magnetization process illustrated in FIG. 11(a), the curved arrow on a magnetic recording medium 100 comprising a magnetic layer 102 formed on a substrate 101 shows the path of movement of a permanent magnet for magnetic duplication. Magnetic layer 102 is homogeneously magnetized in a circumferential direction.

In the positioning process illustrated in FIG. 11(b), the master disk 1 for magnetic duplication is disposed in position on the magnetic recording medium 100. In the step of transferring signal patterns shown in FIG. 11(c), the master disk is put in contact with the magnetic recording medium 100, and the permanent magnet 110 for magnetic duplication is moved along the path depicted by the curved arrow to perform magnetic duplication.

FIGS. 12(a) and 12(b) illustrate an outline of the magnetic duplication for the magnetic recording medium 100. FIG. 12(a) is a cross-sectional view showing an initial homogeneous magnetization process where a permanent magnet 110 is moved over the magnetic recording medium 100 with a constant gap of less than 1 mm.

The magnetic film deposited on the substrate is not magnetized in one direction in the beginning, and is magnetized in this initial homogeneous magnetization process in one direction by leakage flux in the gap of the permanent magnet 110. The arrows depicted in the magnetic film 102 in FIGS. 12(a) and 12(b) indicate the direction of magnetization.

The step of transferring a signal pattern shown in FIG. 12(b) illustrates the magnetic duplication process. The master disk 1 comprises soft magnetic films 10, cobalt-based soft magnetic films for example, embedded on the surface portion of a silicon substrate 1a opposite to the medium surface.

The permanent magnet 110 generates a leakage magnetic field for writing duplication signals, the direction of which is reversed from the direction of the magnetic field in the initial homogeneous magnetization process. In the arrangement where the master disk 1 having a pattern of embedded soft magnetic films 10 intervenes between the permanent magnet 110 and the magnetic recording medium 100, a leakage magnetic field from the permanent magnet 110 penetrates through the silicon substrate 1a and magnetizes magnetic layer 102 in the region without the soft magnetic films 10. In the position of soft magnetic films 10 in the pattern, the leakage flux flows within the soft magnetic films 10 because the magnetic flux takes the path of minimum reluctance.

Accordingly, the leakage magnetic flux through the silicon substrate 1a is small in the position of the soft magnetic films 10. Thus, magnetization is not newly written in the magnetic recording medium.

Patterns on the master disk 1 are conventionally not product servo patterns 20 as shown in FIG. 13. Rather, they are reference servo patterns 30, as shown in FIG. 14, which serve as a base for self-generating the product servo patterns in a hard disk.

The reference servo pattern 30 is imposed in order that the magnetization can be securely reversed in the process of magnetic duplication using a master disk 1, by the external field in the portion of the magnetic recording medium 100 that just opposes the location of the master disk 1 at which a soft magnetic film 10 is absent. Here, the minimum line width of the reference servo pattern 30 is about 1.5 μm, while that of the product servo pattern 20 is 0.35 μm. The instructions include:

1) Patterns other than the burst pattern, for example a preamble pattern, do not change in the radial direction (R direction) and only change in the circumferential direction (? direction), which is the direction along a track.

2) The burst pattern 5 is an isolated pattern that is composed of isolated magnetic films.

The following describes problematic points in magnetic duplication using a master disk 1 on which a reference servo pattern 30 is formed.

1) Errors in the process of forming the reference servo pattern 30 affect the product servo pattern 20, which is not a situation suited for high density recording.

2) The effect of magnetic duplication would be enhanced if the magnetic duplication pattern could include OS and contents in addition to the reference servo pattern 30.

Relating to the point 2) in particular, recording of only the servo pattern is sufficient in an externally installed hard disk, while hard disks installed within an apparatus, for example as now installed in a personal computer, are equipped with pre-installed OS and application software at the time of shipment. It will be very effective to magnetically duplicate those types of software, too. Thus, a technique is expected to be developed that allows magnetic duplication of the product servo pattern and the data pattern.

The product servo patterns 20 as shown in FIG. 13 stored in conventional HDDs each can be classified into one of three patterns described below, and enlarged views thereof are shown in FIGS. 15 through 18.

1) FIG. 15 shows a pattern that does not change in the radial direction (R direction) and changes only in the circumferential direction (? direction). A typical pattern of this type is a preamble pattern 2 that performs amplitude adjustment of readout signals and clock extraction from the readout signals.

2) FIG. 16 shows an isolated pattern composed of isolated magnetic films. A burst pattern 5 is this type of pattern. The burst pattern detects the position of the magnetic head.

3) FIG. 17 and FIG. 18 show patterns that differ from the above two types. The pattern of FIG. 17 corresponds to irregular patterns including servo detection pattern 3 and patterns for the servo address information (track number 4a and sector number 4b). The pattern of FIG. 18 corresponds to an entirely irregular pattern such as a contents pattern.

The areas in each of FIGS. 15 through 18 surrounded by closed lines define a zone where soft magnetic film 10 is formed in the master disk 1.

Japanese Unexamined Patent Application Publication No. 2001-283433 discloses a technique to avoid errors in detection of a readout signal. The technique avoids such errors by correcting pulse shifts of the readout signal that are detected as corresponding to the soft magnetic pattern of the master carrier.

Japanese Unexamined Patent Application Publication No. 2002-216343 discloses a technique to prevent occurrences of signal loss by enhancing intimate contact between a slave medium and a master carrier. The intimate contact is made possible by forming air suction paths, which in turn are formed by the pattern of protrusions and recesses in the master carrier with the width of the protrusions being smaller than the track pitch.

Magnetic duplication can be carried out without problem for the preamble pattern 2 and the burst pattern 5 of the three types of product patterns 20. However, in the pattern types illustrated in FIGS. 17 and 18, an area surrounded by a soft magnetic film 10, as shown in FIGS. 19(a), 19(b) and 19(c) (hereinafter, such an area is referred to as a special region A), cannot be magnetically duplicated.

Although FIGS. 12(a) and 12(b) are cross-sectional views of magnetic duplication, the magnetic flux actually flows in a three-dimensional space and take a path of minimum reluctance. In the patterns of FIGS. 19(a), 19(b) and 19(c), in the special region A, in which soft magnetic film 10 is absent, ideally all the magnetic flux from the external field would flow in the magnetic recording medium 100 in intimate contact with the master disk 1. However, the magnetic flux actually tends to flow in the adjacent soft magnetic film 10 that exhibits less reluctance. As a result, only a small fraction of the magnetic flux from the external field can flow in the portion of the magnetic recording medium 100 intimately contacting the master disk 1.

In a case of a small duplication field, in particular, the special region A surrounded by the pattern of the soft magnetic film 10 as shown in FIGS. 19(a), 19(b) and 19(c), has a problem that the reversal of magnetization as shown in FIG. 12(b) cannot be performed. As a result, so-called bit loss occurs in the readout signals from the magnetic recording medium 100 with the magnetic pattern transferred from the master disk 1. Thus, ideal duplication hardly ever can be performed.

A more specific description is now provided. FIG. 10 is an enlarged top plan view of a master disk 1. The special region A (marked by hatching) surrounded by a pattern of soft magnetic films 10 is an area where reversal of magnetization is difficult. This special region A has a relatively small area and is surrounded by a soft magnetic film 10 in close proximity. In the magnetic duplication process using a permanent magnet 110 as shown in FIG. 12(b), the applied magnetic field collectively flows in the surrounding soft magnetic film 10 and is not led to the special region A in the central region.

Because a soft magnetic film 10 does not exist in the special region A, a sufficiently large magnetic flux should be applied to the magnetic recording medium 100 in the location that is opposing the special region A and magnetically transferred from that area. Nevertheless, the special region A is surrounded by the soft magnetic film 10 in close proximity, so that sufficient magnetic flux cannot be applied.

Since sufficiently large magnetic flux is not led to the slave magnetic recording medium 100 at the location opposing the special region A, a reversal of magnetization is not performed, resulting in incorrect magnetic duplication. Because of this incorrect magnetic duplication according to the technique of magnetic duplication, some information data that is to be recorded on the magnetic recording medium 100 as a correct value of “1” may be recorded incorrectly as value of “0”. Thus, there is a problem that highly reliable magnetic duplication is impossible.

### OBJECT AND SUMMARY OF THE INVENTION

Accordingly, an object of the invention is to provide a master disk for magnetic duplication allowing a highly reliable magnetic duplication technique to be performed. Another object is to provide a method for manufacturing such a master disk. A master disk and a method of manufacture according to the invention allow an elimination of bit loss in a magnetic recording medium having a magnetic pattern transferred from the master disk. For achieving this, a region is provided where reversal of magnetization by a transferring field is obtained, even in the area surrounded by a shaped pattern of soft magnetic films.

One aspect of the invention is a master disk for magnetic duplication that includes duplication patterns that are magnetically duplicated to a magnetic recording medium. A pattern of soft magnetic films embedded in the master disk is arranged in a radial direction and circumferential direction surrounding a special region that has an area equal to an area of a division of one recordation pixel. The special region is a magnetic transfer region consisting of a magnetization reversible area that is magnetically transferred and a magnetization irreversible area that is not magnetically transferred.

The magnetization reversible area is formed in a central region of the division of a recordation pixel and a magnetic flux of an externally applied magnetic field is collectively led to the magnetization reversible area with very little influence from the pattern of soft magnetic films, and the magnetization reversible area constitutes a part of a magnetic path having a minimum reluctance for the magnetic flux of an externally applied magnetic field. The magnetization irreversible area is formed around the magnetization reversible area and under the influence of the pattern of soft magnetic films, the externally applied magnetic field is not led to the magnetization irreversible area. The magnetization irreversible area constitutes a magnetic path having a larger reluctance for the magnetic flux of the externally applied magnetic field than the reluctance of the magnetic path including of the magnetization reversible area.

Each soft magnetic film, of the pattern of soft magnetic films surrounding the magnetization reversible area and the magnetization irreversible area of the magnetic transfer region, preferably has a width in the radial direction smaller than a track pitch. Also, a width in the circumferential direction of each such soft magnetic film preferably is smaller than a line pitch. Preferably, the width in the radial direction is about half the track pitch, or the width in the circumferential direction is about half the line pitch.

The pattern of soft magnetic films preferably is embedded along lines of the radial direction and the circumferential direction in duplication patterns other than a burst pattern used for positioning of the magnetic head.

Another aspect of the invention is a method of manufacturing a master disk for magnetic duplication. The master disk is to have embedded therein duplication patterns to be magnetically duplicated to a magnetic recording medium, and a pattern of soft magnetic films.

The method includes arranging the pattern of soft magnetic films in a radial direction and a circumferential direction surrounding a special region that has an area equal to an area of a division of one recordation pixel. A magnetization reversible area is formed in a central region of the division of a recordation pixel. The magnetization reversible area is formed so that a magnetic flux of an externally applied magnetic field is collectively led to the magnetization reversible area unaffected by the pattern of soft magnetic films. Moreover, the magnetization reversible area constitutes a part of a magnetic path having a minimum reluctance for the magnetic flux of an externally applied magnetic field. The method also includes forming a magnetization irreversible area around the magnetization reversible area. This area is formed so that under the influence of the pattern of soft magnetic films, the externally applied magnetic field is not led to the magnetization irreversible area. The magnetization irreversible area that is formed constitutes a magnetic path having a larger reluctance for the magnetic flux of the externally applied magnetic field than does the reluctance of the magnetic path including the magnetization reversible area.

Preferred embodiments according to the invention will be described in detail below with reference to accompanying drawings:

### BRIEF DESCRIPTION OF THE DRAWINGS

FIG. 1 is a plan view showing surrounding shape patterns of soft magnetic films on a master disk of a first embodiment of the invention. Surrounding shape patterns according to the prior art are also shown for comparison.

FIG. 2 is a plan view of an enlarged pattern of soft magnetic films according to the invention.

FIG. 3(a) through FIG. 3(e) show a process for manufacturing a master disk to form a pattern of soft magnetic films according to the invention.

FIG. 4 illustrates a relationship between a burst pattern and data tracks.

FIG. 5(a) through FIG. 5(d) illustrate waveforms obtained on detecting the patterns by a magnetic head.

FIG. 6 is a flow chart showing signal processing of detected waveform.

FIG. 7(a) illustrates readout signals from a soft magnetic film of a pattern of soft magnetic films according to the prior art, and FIG. 7(b) illustrates readout signals from a soft magnetic film of a pattern of soft magnetic films according to the invention.

FIG. 8 is a plan view showing one variation of a pattern of soft magnetic films in which a length in the circumferential direction is not restricted, in accordance with a second embodiment of the invention.

FIG. 9 is a plan view showing another variation of a pattern of soft magnetic films in which a length in the radial direction is not restricted, in the second embodiment of the invention.

FIG. 10 illustrates surrounding shape patterns of soft magnetic films according to the prior art.

FIG. 11(a) through FIG. 11(c) illustrate a process of magnetic duplication of a magnetic recording medium.

FIG. 12(a) and FIG. 12(b) illustrate an outline of a process of magnetic duplication of a magnetic recording medium.

FIG. 13 illustrates a product servo pattern.

FIG. 14 illustrates a reference servo pattern.

FIG. 15 illustrates a preamble pattern as an example of a pattern that does not vary in the radial direction and only varies in the circumferential direction.

FIG. 16 illustrates a burst pattern as an example of an isolated pattern.

FIG. 17 illustrates a servo pattern as a type of entirely irregular pattern.

FIG. 18 illustrates a contents pattern as another type of entirely irregular pattern.

FIG. 19(a) through FIG. 19(c) illustrate examples of patterns that are difficult to be magnetically duplicated.

### DETAILED DESCRIPTION OF THE PREFERRED EMBODIMENTS

### First Embodiment

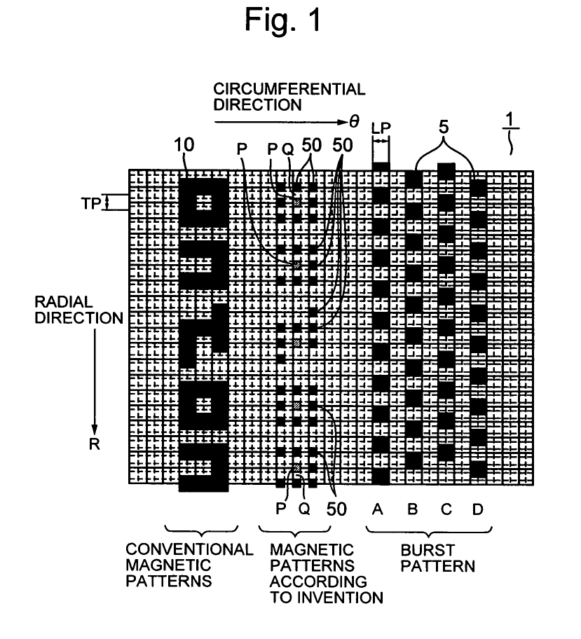

A first aspect of embodiment of the invention will be described with reference to FIGS. 1 through 7.

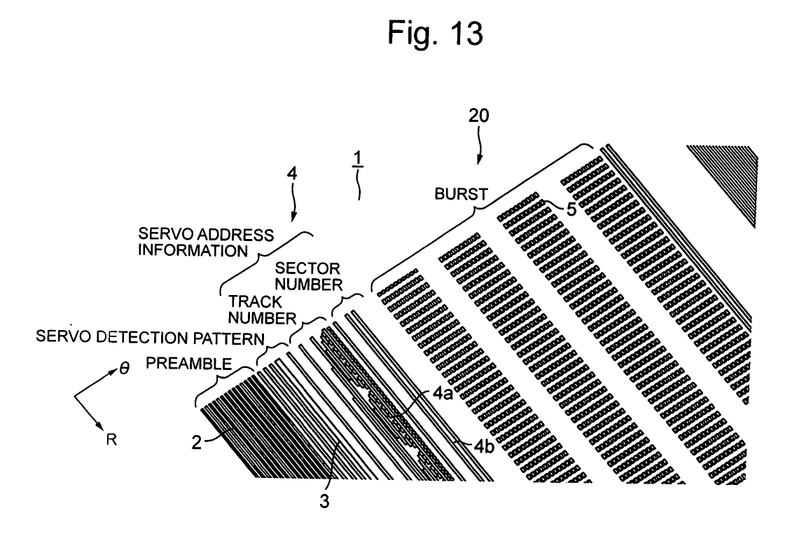

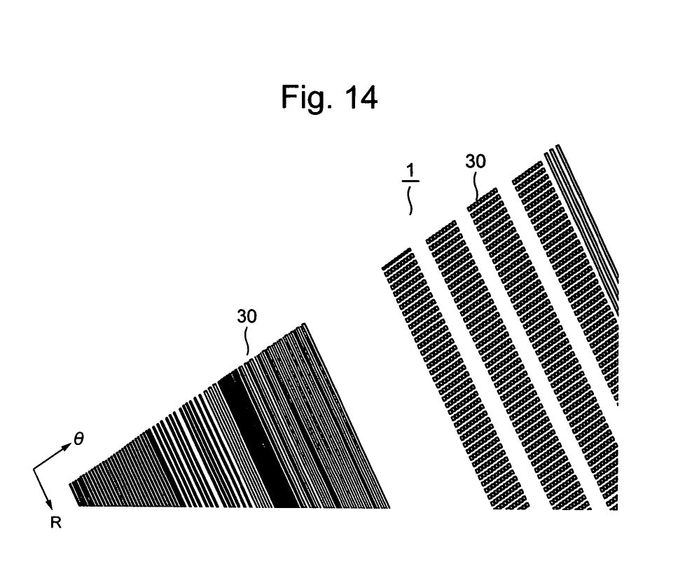

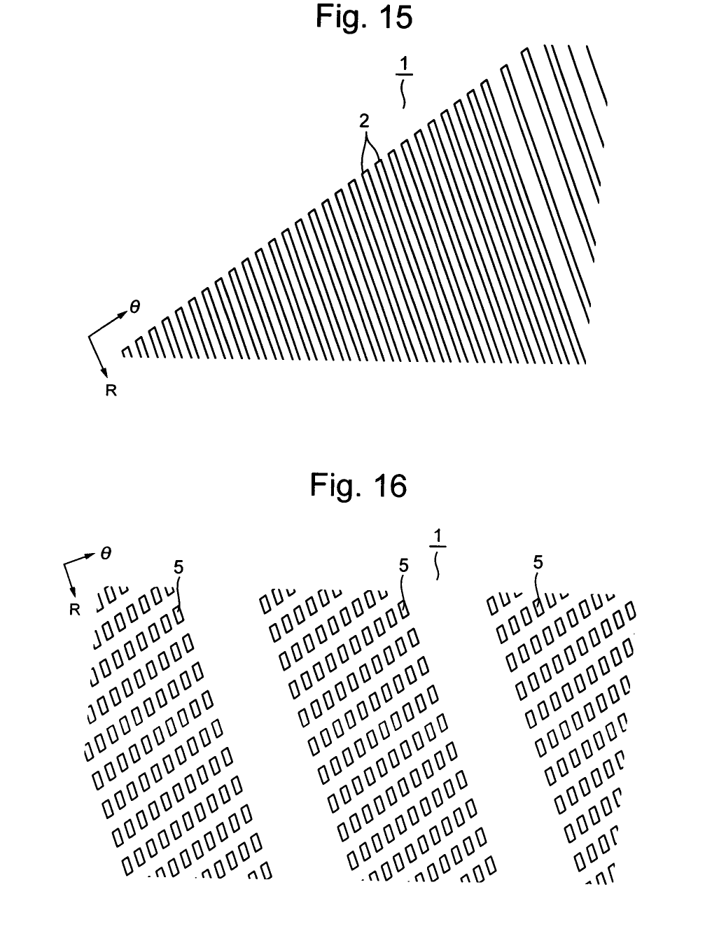

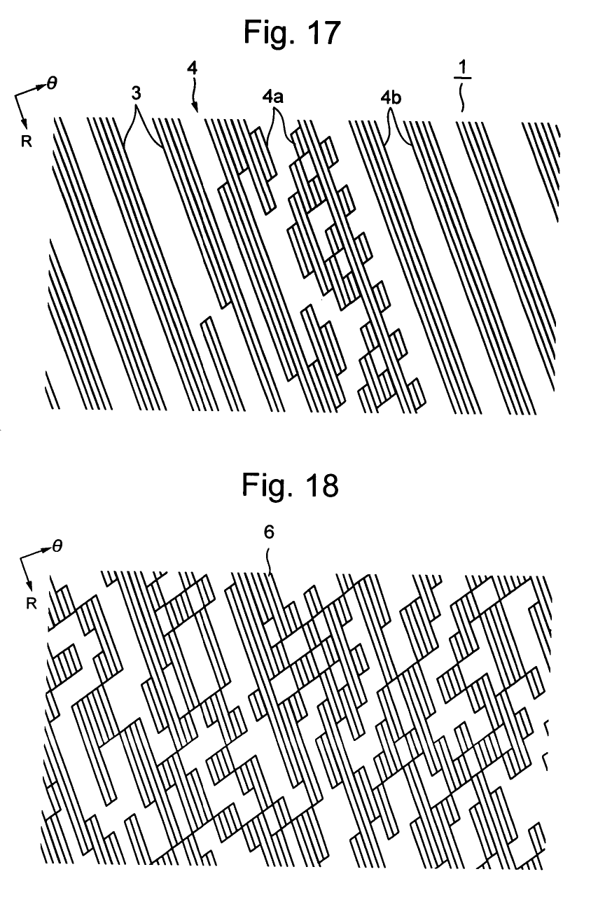

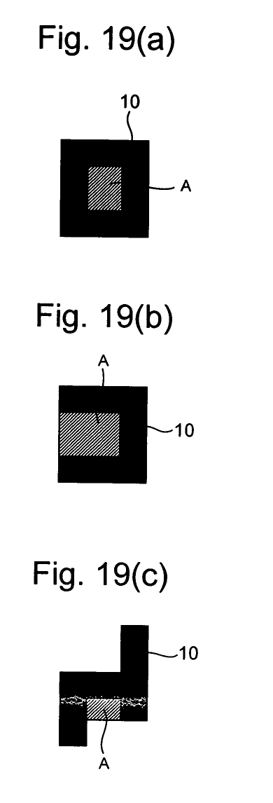

FIG. 1 shows patterns on a master disk 1. The master disk has patterns of soft magnetic films 50 according to the invention embedded on its surface. For comparison, also illustrated on the disk surface of FIG. 1 are conventional patterns of soft magnetic films 10, magnetic duplication of which is difficult to obtain. A burst pattern 5 also is illustrated in FIG. 1. Patterns other than the pattern of soft magnetic films 50 are the same as the patterns illustrated in FIG. 13 and FIG. 14.

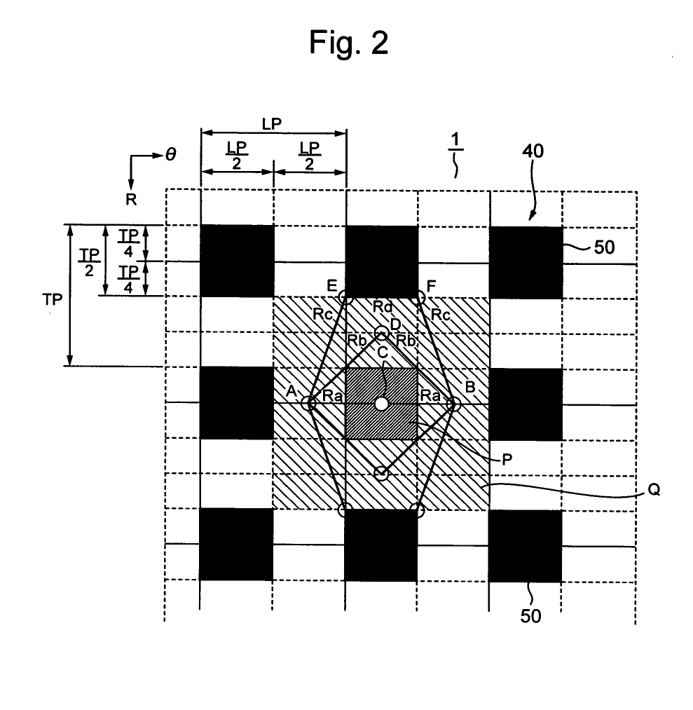

FIG. 2 is an enlarged illustration of the region shown in FIG. 1 in which the patterns of soft magnetic films 50 are formed. The soft magnetic film 50 of the pattern shown in FIG. 2 has a rectangular shape. A side length in the radial direction is half the track pitch and a side length in the circumferential direction is half the line pitch.

A plurality of soft magnetic films 50 forming a pattern 40 (seven or eight films in this example) are arranged along lines extending in the radial direction and the circumferential direction, around the special regions P and Q, which have a combined area equal to the area of a division for one recordation pixel. Thereby, this plurality of films 50 surrounds the special regions.

The illustrated special region P is formed as an area that allows reliable magnetization reversal in the special region P by a transferring magnetic field. The special region P is positioned at the central portion of the division for one recordation pixel and is a magnetization reversible area in which magnetization can be reversed by the transferring magnetic field. The special region Q is positioned in a peripheral portion around the magnetization reversible area and is a magnetization irreversible area in which magnetization is not reversed by the transferring magnetic field.

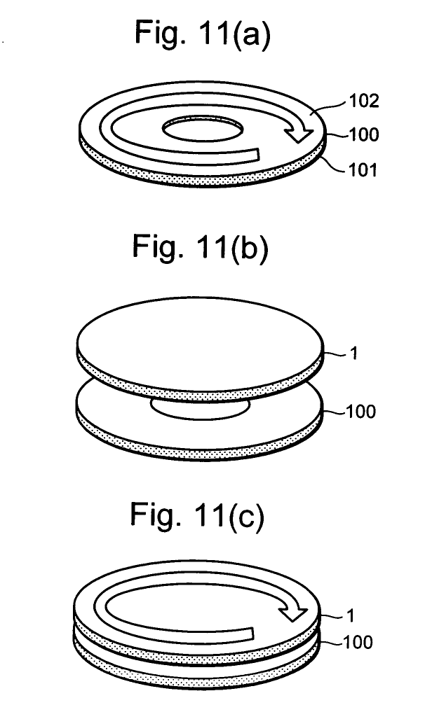

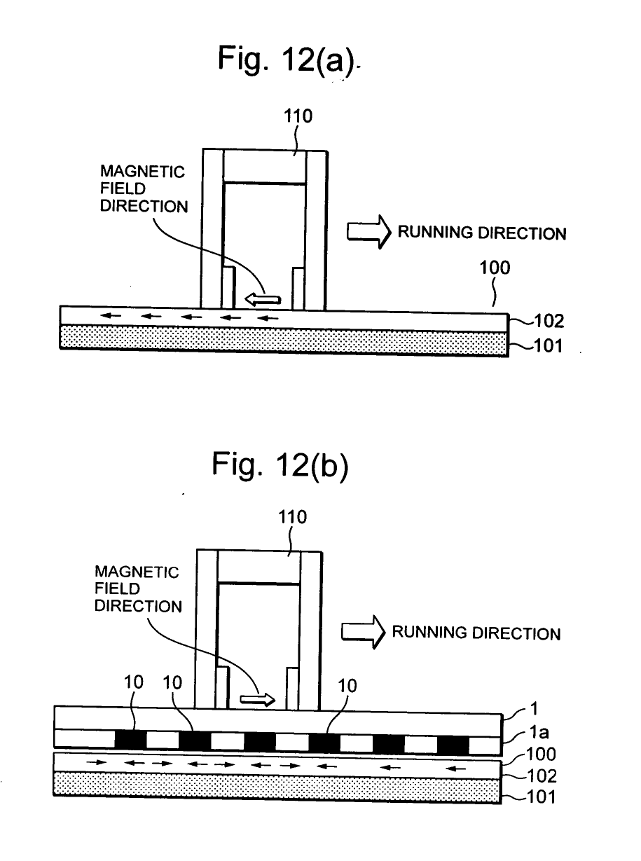

In this exemplary embodiment of the invention, the process of magnetic duplication from the master disk 1 to the magnetic recording medium 100 is the same as the process previously described with reference to FIGS. 11(a), 11(b), 11(c) and FIGS. 12(a), 12(b). That is, the process in the exemplary embodiment also employs a technique of magnetic duplication that uses a signal transferring head, such as a permanent magnet 110.

Principle of Magnetic Duplication

The principle of magnetic duplication using the master disk 1 will be described. In FIG. 1, the solid lines in the radial direction indicate the center of the data track and the dotted lines indicate the positions ±TP/4 apart from the center of the data track. Referring also to FIG. 2, the solid lines along the radial direction show the position of line change and the dotted lines shows the ±LP/2 positions relative to the position of line change. Here, TP represents a track pitch, and LP represents the line pitch.

A conventional pattern of soft magnetic films 10 is formed with TP and LP as unit lengths. In contrast, a pattern of soft magnetic films 50 according to the invention is formed with TP/2 and LP/2 as lengths of the unit of the magnetic films, the periods of the unit being TP and LP. Regions without the magnetic film with side lengths of TP/2 and LP/2, are provided between the units of magnetic films. As a result, the magnetic films are isolated from each other.

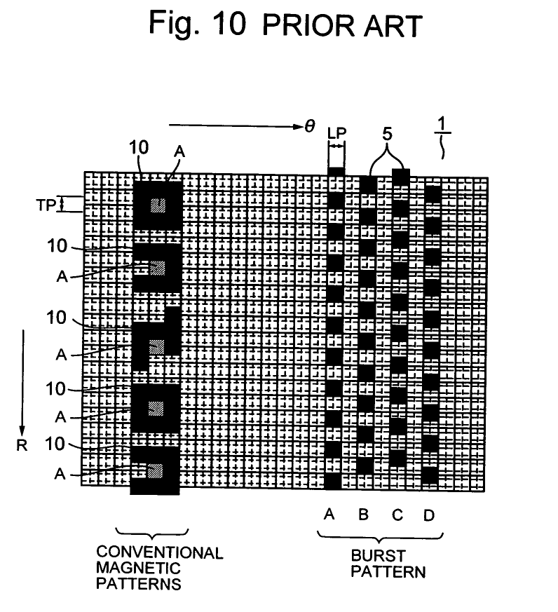

FIG. 2 also illustrates flow of magnetic flux based on the laws of physics, in the special regions P and Q surrounded by a pattern of the soft magnetic films 50 shown in FIG. 1. The black rectangular areas in FIG. 2 represent soft magnetic films 50. The area with hatching positioned in the center represents the special region P, which conventionally was hard to magnetically duplicate. (See the special region A in FIG. 10.) The special region P in the invention is a magnetization reversible area that allows magnetic duplication.

Special regions Q are formed around the special region P, that is, in the neighboring area of the magnetization reversible area. The special regions Q are magnetization irreversible areas that cannot be magnetically duplicated. The region having at least the special region P of magnetization reversible area and the special regions Q of magnetization irreversible areas, is as a whole here called a magnetization transfer region.

When an external field for magnetic duplication is applied by a permanent magnet 110 as shown in FIG. 12(b), a unidirectional magnetic field is applied in the circumferential (?) direction in FIG. 2. The magnetic flux of the external field tends to take a path of minimum reluctance according to the laws of physics.

The reluctance is inversely proportional to the cross-sectional area and directly proportional to the length of the path of magnetic flux flow. Because the special region P positioned in the central region is separated from the soft magnetic films 50, the flow of the magnetic flux of the external field is hardly affected by the soft magnetic films 50. Consequently, the magnetic flux is led to the central region without significant disturbance.

Now, examining magnetic flux flow from the point A to the point B in FIG. 2, the following three paths can be assumed: a first path A?C?B through the special region P, a second path A?D?B through the special region Q, and a third path A?E?F?B through the special region Q and a soft magnetic film.

Because the reluctance Rd of the soft magnetic film 50 is far smaller than the reluctance Rc of magnetic film 101 of the magnetic recording medium 100, the reluctance Rd of the overall reluctance along the third path R_{AEFB} can be neglected. The reluctance of each path can be represented as follows:

| path | reluctance |
|---|---|
| A?C?B | R_{ACB} = 2 × Ra |
| A?D?B | R_{ADB} = 2 × Rb |
| A?E?F?B | R_{AEFB} = 2 × Rc + Rd = 2 × Rc |

Since the magnitude of the reluctances Ra, Rb, and Rc of the magnetic layer 101 of the magnetic recording medium 100 is proportional to the distance in the magnetic circuit as shown in FIG. 2, the path exhibiting the smallest reluctance is the path A?C?B. Consequently, magnetic flux flows in the special region P (indicated by hatching) where magnetic duplication was conventionally difficult, even through the soft magnetic films 50 exist around the special region. An external field can be applied to the magnetic recording medium 100 in contact with the master disk 1, thereby allowing the reversal of magnetization as in the transferring process shown in FIG. 12(b) in this special region P of the magnetization transfer region.

Therefore, the special regions P and Q can be defined as follows. The special region P (a magnetization reversible area) is an area where the magnetic flux of the external field flows with very little influence of the pattern of soft magnetic films 50 and is collectively led to the central region. The special region P is formed as a part of the magnetic path of minimum reluctance against magnetic flux flow. On the other hand, the special region Q (a magnetization irreversible area) is an area where the magnetic flux of an external field tends to flow to the soft magnetic films 50 with smaller reluctance affected by the pattern of soft magnetic films 50 and is not lead to the special region Q. The special region Q is formed as a magnetic path having greater reluctance than a magnetic path including the magnetization reversible area.

Method of Manufacture

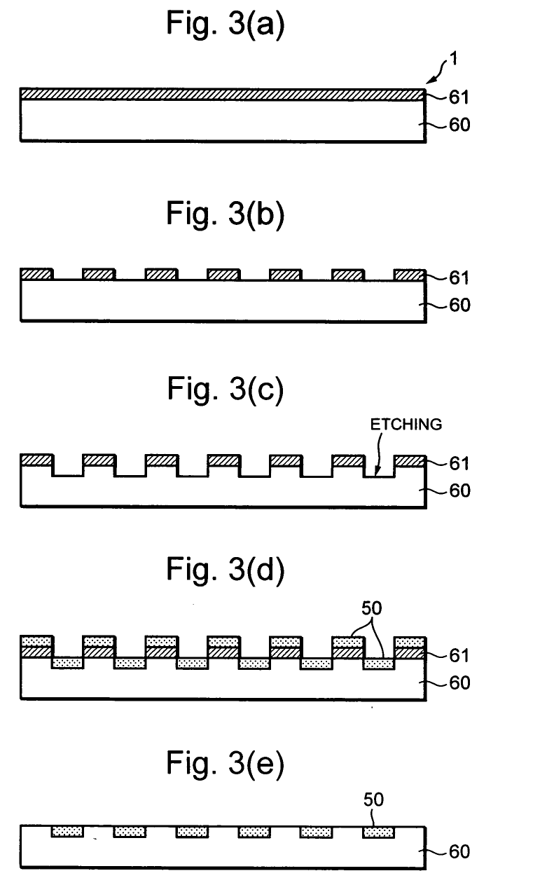

A method of manufacturing a master disk 1 will be described below with reference initially to FIGS. 3(a)-3(e). Such a disk 1 is to be used in the magnetic duplication of servo signals by a mechanism shown in FIGS. 12(a) and 12(b).

In a first step of the method, shown in FIG. 3(a), a resist film 61 having thickness of 1.2 μm is applied using a spin coater to the surface of a silicon substrate that is about 500 μm thick. Then, in a second step shown in FIG. 3(b), patterning is performed upon the resist film by means of a photolithographic procedure similar to a method used in manufacturing usual silicon semiconductors.

The resist film is used as a mask for etching in the third step shown in FIG. 3(c). Since the resist film is made of novolac, which is not very resistant to etching, it is important for the resist film to have sufficient thickness so as not to melt out. In the third step, the silicon substrate 60 is dry etched to a depth of 500 nm employing reactive plasma etching using a methyl trichloride reactive gas, to form grooves.

In a fourth step shown in FIG. 3(d), the soft magnetic film 50 is deposited to a thickness of 500 nm by means of a sputtering method leaving the resist film 61, to embed the soft magnetic films 50 in the grooves.

Patterns of soft magnetic films 50 are formed with the unit lengths of half the track pitch in the radial direction and half the line pitch in the line direction. This step is performed so that soft magnetic films are isolated from each other as shown in FIG. 1, except that step is not performed, out of the three above-described types of the magnetic patterns formed on the magnetic recording medium 100, for the isolated pattern such as burst pattern 5 and the patterns, such as preamble pattern 2, that are invariable in the radial direction and only variable in the circumferential direction.

In the fifth step shown in FIG. 3(e), the silicon substrate 60 is immersed in a solvent that dissolves the resist film after deposition of the magnetic films 50, while ultrasonic energy also is applied as required. As a result, the resist films 61 between the soft magnetic films 50 and the silicon substrate 60 are dissolved and removed.

A master disk produced by the above-described manufacturing method allows perfect avoidance of bit loss in a magnetic recording medium having magnetic patterns transferred from the master disk. That means the bit error rate of the medium is zero.

Readout Process of Information

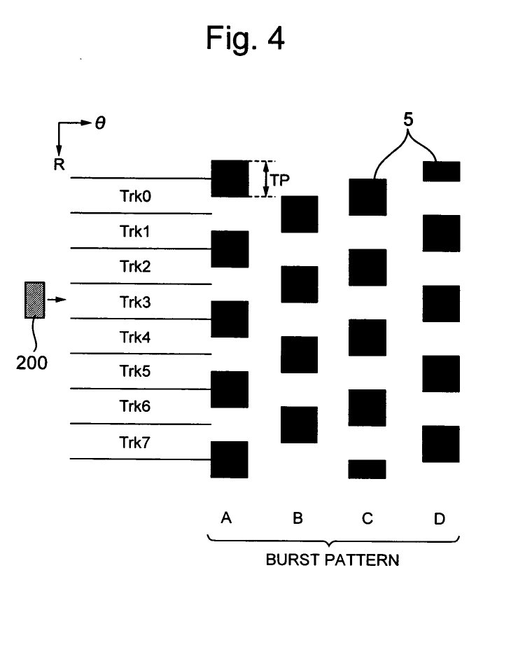

A process of readout information recorded on a magnetic recording medium 100 that is duplicated using the master disk 1 is described referring to FIG. 4 through FIG. 7.

FIG. 4 shows a relationship between a burst pattern 5 and data tracks. The figure shows the positions of the tracks Trk 0 through Trk 7 in the case of the data plane servo system. The burst pattern 5 is illustrated as four patterns A,B, C and D at different circumferential positions of the soft magnetic films thereof radially spaced in relation to tracks Trk 1-Trk 7. Thus, the burst pattern 5 indicates the position of the magnetic head 200 relative to the track center.

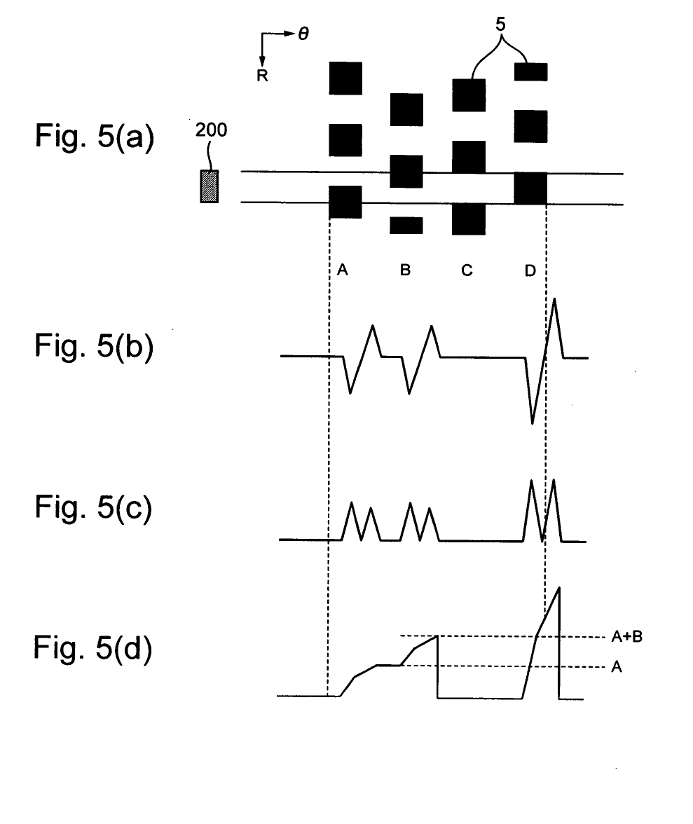

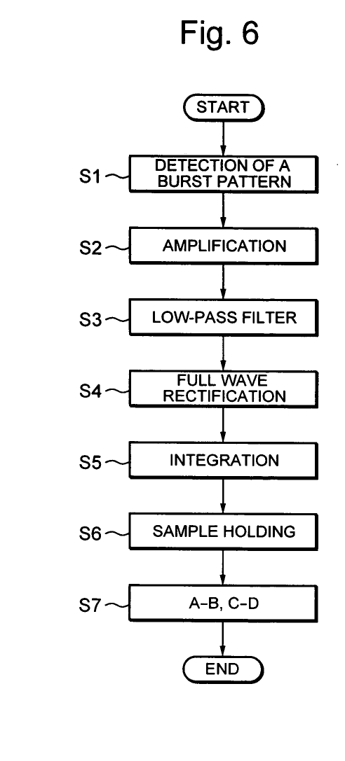

FIG. 5(a) through FIG. 5(d) show the waveforms obtained upon detecting the pattern by the magnetic head 200. FIG. 6 is a flow chart showing signal processing of a detected waveform.

In step S1, the magnetic head 200 is moved circumferentially on the burst pattern A through D shown in FIG. 5(a) to detect pattern signals. In steps 2 and 3, the detected signals are amplified and passed through a low-pass filter to read out the signal waveforms shown in FIG. 5(b).

In step S4, the read-out waveform is full-wave rectified to obtain a rectified waveform of the signal as shown in FIG. 5(c). In step S5, the rectified waveform is integrated to obtain the integrated waveform shown in FIG. 5(d), wherein the integration is reset between the pattern B and the pattern C.

In step S6, sampling is executed at four points from the integrated waveform of the signal, to extract sampling signals corresponding to the values A, A+B, C, and C+D, where here A, B, C, and D represent signal values corresponding to the circumferential positions of the patterns identically designated in FIGS. 4 and 5(a)-5(d). In step S7, the values of the four sampling signals are computed by a computing element to calculate values A−B and C−D.

A−B is if C−D>0 and—(A−B) is output if C−D=0. Thus, a position signal detected by the magnetic head 200 is generated in a form of an analog voltage over the whole width of one track.

As described above, the data track is determined by the burst pattern 5, and generally, a track pitch TP is equal to a length of the burst pattern 5 in the radial direction. The line pitch LP is equal to the line width in the circumferential direction of the preamble pattern 2 that generates the clock frequency, and usually is the same as the line width of the burst pattern in the circumferential direction.

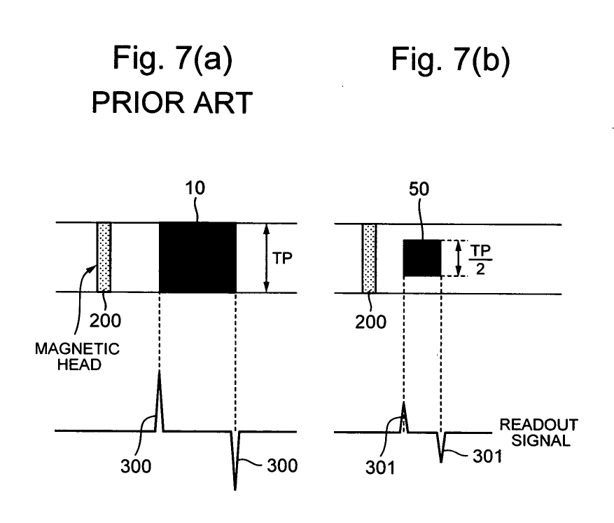

The pattern of soft magnetic films 50 according to the invention is applied to patterns other than the isolated patterns such as the burst pattern 5 and patterns, such as the preamble pattern 2, which are invariable in the radial direction and variable only in the circumferential direction. As a result, the magnitude of the readout waveform of the signals differs as between the readout signal 300 from the pattern of the soft magnetic films 10 of FIG. 7(a) (where the invention is not applied), and the readout signal 301 from the pattern of the soft magnetic film 50 of FIG. 7(b) (where the invention is applied). Compensation for the difference, however, can be obtained by a measure using an appropriate electronic circuit.

Thus, the problem that the pulse interval of the readout signals from the magnetic head 200 is halved due to half length in the circumferential direction of the magnetized region is solved by doubling the sampling frequency just in that region. Further, the problem that the amplitude of the readout signals from the magnetic head 200 is halved due to half length in the radial direction of the magnetized region is solved by doubling the gain of the AGC (Auto Gain Control) amplifier just in that region.

### Second Embodiment

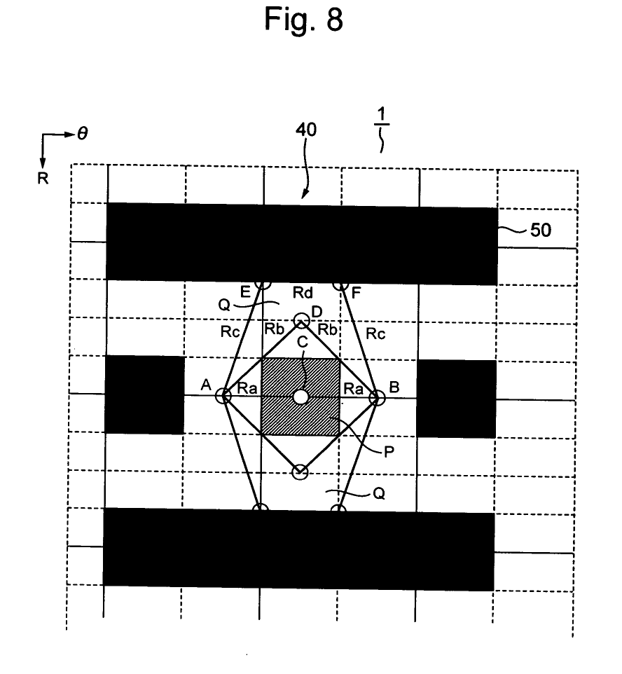

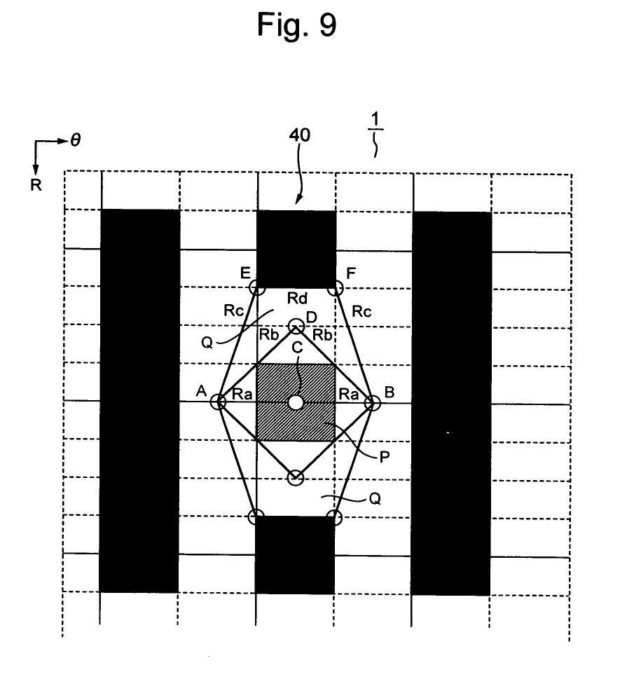

A second aspect of the invention will be described referring to examples illustrated in FIG. 8 and FIG. 9. According to this aspect, some variations of the pattern of soft magnetic films 50 are provided. The soft magnetic films 50 in the first embodiment described above have a rectangular shape with the lengths in the radial direction and the circumferential direction being half the respective pitch. However, the shape of the soft magnetic film is not limited to this configuration. In the example of FIG. 8, the length in the radial direction is limited to half the track pitch, but no limitation is imposed upon the length in the circumferential direction. In the example of FIG. 9, the length in the circumferential direction is limited to half the line pitch, but no limitation is imposed upon the length in the radial direction.

As shown by the examples, the configuration of the pattern of the soft magnetic films 50 is not limited to a special form, as long as the region surrounded by a pattern of soft magnetic films 50 in the radial direction and in the circumferential direction, includes a region with an area of a division of one recordation pixel consisting of a special region P (of a magnetization reversible area that can be magnetically transferred) and a special region Q (of a magnetization irreversible area that cannot be magnetically transferred).

With this feature of the master disk, the special region allows securing reversal of magnetization by a transferring magnetic field.

What is claimed is:

1. A master disk for magnetic duplication comprising:
duplication patterns that are magnetically duplicated onto a magnetic recording medium; and
a pattern of soft magnetic films embedded in the master disk, arranged in a radial direction and a circumferential direction surrounding a special region that has an area equal to an area of a division of one recordation pixel, the special region being a magnetic transfer region consisting of a magnetization reversible area that is magnetically transferred and a magnetization irreversible area that is not magnetically transferred, wherein
the magnetization reversible area is formed in a central region of the division of a recordation pixel and a magnetic flux of an externally applied magnetic field is collectively led to the magnetization reversible area, and the magnetization reversible area constitutes a part of a magnetic path having a minimum reluctance for the magnetic flux of an externally applied magnetic field, and
the magnetization irreversible area is formed around the magnetization reversible area, the externally applied magnetic field is not led to the magnetization irreversible area, and the magnetization irreversible area constitutes a magnetic path having a larger reluctance for the magnetic flux of the externally applied magnetic field than the reluctance of the magnetic path including the magnetization reversible area.

2. A master disk for magnetic duplication according to claim 1, wherein the pattern of soft magnetic films is embedded along a line of the radial direction and along a line of the circumferential direction in the duplication pattern wherein the duplication pattern is other than a burst pattern used for positioning of a magnetic head.

3. A master disk for magnetic duplication according to claim 1, wherein each magnetic film forming the pattern of soft magnetic films surrounding the magnetization reversible area and the magnetization irreversible area of the magnetic transfer region has a width in the radial direction smaller than a track pitch.

4. A master disk for magnetic duplication according to claim 3, wherein the pattern of soft magnetic films is embedded along a line of the radial direction and along a line of the circumferential direction in the duplication pattern, wherein the duplication pattern is other than a burst pattern used for positioning of a magnetic head.

5. A master disk for magnetic duplication according to claim 3, wherein each soft magnetic film in the pattern of soft magnetic films has the width in the radial direction of about half the track pitch.

6. A master disk for magnetic duplication according to claim 5, wherein the pattern of soft magnetic films is embedded along a line of the radial direction and along a line of the circumferential direction in the duplication pattern, wherein the duplication pattern is other than a burst pattern used for positioning of the magnetic head.

7. A master disk for magnetic duplication according to claim 3, wherein each soft magnetic film in the pattern of soft magnetic films surrounding the magnetization reversible area and the magnetization irreversible area of the magnetic transfer region, has a width in the circumferential direction smaller than a line pitch.

8. A master disk for magnetic duplication according to claim 7, wherein the pattern of soft magnetic films is embedded along a line in the radial direction and along a line in the circumferential direction in the duplication pattern, wherein the duplication pattern is other than a burst pattern used for positioning of a magnetic head.

9. A master disk for magnetic duplication according to claim 7, wherein the width in the circumferential direction of each soft magnetic film in the pattern of soft magnetic films is about half the line pitch.

10. A method for manufacturing a master disk for magnetic duplication having duplication patterns that are magnetically duplicated onto a magnetic recording medium, and a pattern of soft magnetic films, the duplication patterns and the pattern of soft magnetic films being embedded in the master disk, the method comprising:
arranging the pattern of soft magnetic films in a radial direction and a circumferential direction surrounding a special region that has an area equal to an area of a division of one recordation pixel;
forming a magnetization reversible area in a central region of the division of a recordation pixel, wherein a magnetic flux of an externally applied magnetic field is collectively led to the magnetization reversible area, and the magnetization reversible area constitutes a part of a magnetic path having a minimum reluctance for the magnetic flux of an externally applied magnetic field; and
forming a magnetization irreversible area around the magnetization reversible area, wherein the externally applied magnetic field is not led to the magnetization irreversible area, and the magnetization irreversible area constitutes a magnetic path having a larger reluctance for the magnetic flux of the externally applied magnetic field than the reluctance of the magnetic path including the magnetization reversible area.
